(19) United States
(12) Patent Application Publication
(10) Pub. No.: US 2010/0261381 A1
(43) Pub. Date: Oct. 14, 2010

(54) COMPRESSION CONNECTOR FOR COAXIAL CABLES

(75) Inventors: Noah Montena, Syracuse, NY (US); David Jackson, Manlius, NY (US); Daniel Robb, East Syracuse, NY (US)

Correspondence Address: John Mezzalingua Associates, Inc.;c/o Hiscock & Barclay, LLP, One Park Place, 300 South State Street, Syracuse, NY, 13202, US

(73) Assignee: John Mezzalingua Associates, Inc., East Syracuse, NY (US)

(21) Appl. No.: 12/421,826

(22) Filed: Apr. 10, 2009

(51) Int. Cl. H01R 9/05

(52) U.S. Cl. 439/584

(57) ABSTRACT

A compression connector for engaging a coaxial cable having a plurality of center conductors includes a connector body, an insulator disposed within a center passageway of the body and a compression sleeve attached for axial movement relative to the body. The multiple center conductors of an engaged coaxial cable end are seized when advanced a predetermined axial distance into openings in the insulator within corresponding conductive pins.

### FIELD OF THE INVENTION

The application generally relates to the field of coaxial cable termination and more specifically to a compression connector that can seize multiple center conductors of an engaged coaxial cable end.

### BACKGROUND OF THE INVENTION

Coaxial cables are conventionally used as a transmission medium installed on a widespread basis for purposes of carrying signals for communication networks, such as cable television (CATV) and computer networks among others. A coaxial cable used for these purposes must, at some point, be connected to network connector ports. Typical coaxial cables, such as 75 ohm and 50 ohm cables, are defined by a center conductor, an outer conductor and an intermediate dielectric foam layer disposed therebetween in which the outer conductor layer is covered by a protective sheath. The center conductor, for example in certain 50 ohm cables, can be solid in terms of its construction or alternatively hollow so as to reduce material usage and stiffness. Coaxial cables can also include smooth-walled and corrugated versions depending on the application, magnitude of signals to be carried, and other factors.

When affixing a cable connector to a corrugated coaxial cable, for example, it is necessary to provide both good electrical and mechanical contact between the cable connector and center and outer conductors of a prepared coaxial cable end. It is also desirable to connect each of the center and outer conductors without having to reposition the cable connector during the connection operation.

Certain compression-type cable connectors have been developed that can effectively seize each of the outer and inner conductors of a prepared coaxial cable. There are other cable designs, however, that could utilize a plurality of center conductors but in which proper mechanical and electrical engagement is also required.

It is therefore desirable to develop a compression connector that can be used in relation with such types of cables.

### SUMMARY OF THE INVENTION

According to one aspect, there is provided a compression connector for coaxial cables having more than one center conductor, the connector comprising a connector body, an insulator disposed within a center passageway of said body, a compression sleeve attached for axial movement relative to said body and means for seizing each of the center conductors of an engaged coaxial cable end. In one version, the connector further includes a corresponding number of conductive pins that are disposed within axial openings of the insulator wherein each of the conductive pins further include means for seizing each center conductor.

In one disclosed embodiment, each conductive pin includes a collet portion having flexible finger sections that are engaged to close so as to act directly on the center conductor. To that end, the collet portions are disposed outside of the insulator and caused to move axially into the insulator openings when the compression sleeve is advanced. Each insulator opening is defined with a diameter that is smaller than that of a transition surface of the collet portion such that said axial advancement causes the flexible finger sections to move inwardly and close upon or seize the center conductor.

Preferably, a drive element engages the collet portion, the drive element being axially movable with the clamp and compression sleeve. The drive element includes at least one opening enabling the center conductors to initially pass through to the conductive pins.

In another version, the means for seizing the center conductor act when the center conductor is advanced a predetermined distance within the insulator. According to one embodiment, a plurality of spring contacts are disposed within each conductive pin. As the center conductor is advanced, both mechanical and electrical contact is made with the spring contacts, which can include, for example, a plurality of leaf springs equi-spaced circumferentially about the hollow interior of each conductive pin and extending inwardly into the pin cavity.

Still further, means are provided for effectively seizing the outer conductor or outer conductor layer of the coaxial cable. These means, according to one version, include a clamp having an outer annular surface placed in contact with an interior surface of the connector body and an inner annular surface configured to engage the outer conductor layer of an engaged cable end. The clamp is supported for axial movement within the center passageway of the connector body. In one version, the connector body includes an interior surface having two different interior diameters linked by a transitional surface portion wherein the interior surface of the clamp is caused to compress against the outer conductor layer of the coaxial cable when axially displaced across the transitional surface. The clamp itself is provided with means, enabling the clamp to be compressed inwardly under the application of an inwardly applied radial force. Engagement between each of the herein described seizing means and the inner and outer conductors can occur simultaneously or nearly simultaneously or can be made sequentially.

The herein described compression connector can be used with various coaxial cable types, including certain types of corrugated and smooth-walled coaxial cables.

According to another aspect, there is provided a compression connector for a coaxial cable, said cable having an outer conductive layer and a plurality of center conductors, said connector comprising a connector body having a first end, a second end and a center passageway defined between said body ends, an insulator fixedly disposed within said center passageway adjacent said first end, a compression sleeve mounted to said connector body at said second end for axial movement in connection therewith including a drive portion extending into said body, a clamp having an exterior surface in engagement with an interior surface of said body and an interior surface configured for engagement with the outer conductive layer of a coaxial cable end engaged therewith, said clamp being movable axially with said compression sleeve, in which the interior surface of said body includes a first diameter adjacent said first end and a second diameter adjacent said second end that is smaller than said first diameter, said first and second diameters being separated by a transitional surface section. The connector further includes means for seizing the multiple center conductors of the engaged cable end, said means including a plurality of hollow conductive pins extending into axial openings of said insulator, said means being engageable with each of said center conductors when said center conductors are advanced a predetermined distance into the insulator.

In one version, each of the conductive pins includes a collet portion that is defined by a plurality of flexible fingers, the collet portion of each conductive pin extending outside of the insulator opening. The collet portion is larger in diameter than the diameter of the corresponding insulator opening. A drive element engages the collet portion and causes the conductive pin to be driven axially into the insulator opening, wherein the flexible fingers are caused to close about each center conductor and produce seizure. In one version, the drive element is disposed in relation to the clamp wherein axial movement of the compression sleeve produces corresponding movement of the drive element and causes each collet portion to be received at least in part within the insulator, effecting a mechanical and electrical connection with each of the multiple center conductors of the engaged coaxial cable.

In lieu of the collet portions and according to another version, the conductive pins can be fixedly mounted within the insulator and therefore a drive element is not specifically required. A set of spring contacts, such as leaf springs, are equi-spaced and circumferentially disposed within each hollow conductive pin. The spring contacts extend inwardly into the hollow opening of each conductive pin and act to seize the center conductor as it advanced a predetermined distance into the insulator.

According to yet another aspect, there is provided a compression connector for a coaxial cable, said coaxial cable having an outer conductor and a plurality of inner conductors for a coaxial cable, said coaxial cable having an outer conductor and a plurality of center conductors, said connector comprising a connector body having a first end, a second end and a center passageway defined between said body ends, an insulator fixedly disposed within said center passageway adjacent said first end; a compression sleeve mounted to said connector body at said second end for axial movement in connection therewith, said sleeve including a drive portion extending into said connector body; a clamp having an exterior surface in engagement with an interior surface of said body and an interior surface configured for engagement with the outer conductor of a coaxial cable end, said clamp being movable axially with said compression sleeve, in which the interior surface of said body includes a first diameter adjacent said first end and a second diameter adjacent said second end that is smaller than said first diameter, said first and second diameters being separated by a transitional surface section; and a plurality of conductive members disposed within axial openings of said insulator, each of said conductive members having a hollow portion sized to receive an inner conductor, said conductive members each further including at least one seizing element that seizes each inner conductor when said conductors are advanced a predetermined axial distance therein by said compression sleeve.

According to one version, the at least one seizing element is defined by a collet section of each conductive member. The collet section includes a plurality of flexible fingers disposed at an extending end of the conducting member. The collet section is sized to receive an inner conductor, the connector further including a drive element that causes the collet section to be driven into an opening of the insulator causing the collet to close about and seize the conductor when the compression sleeve is advanced and the collet is advanced a predetermined distance within the insulator.

According to another version, the at least one seizing element includes a plurality of spring contacts formed within the conductive member. Each conductive member is fitted within an opening of the insulator and includes a hollow end that receives the inner conductor. When advanced a predetermined axial distance, the spring contacts engage and seize the inner conductors. In one embodiment, a plurality of equi-spaced leaf springs are used, the leaf springs extending into the hollow opening of the conductive member for engaging the axially advancing inner conductor.

As noted, the herein described compression connector can be used with various types of coaxial cable, including certain corrugated and smooth-walled types of coaxial cable.

An advantage of the herein described compression connector is that mechanical and electrical attachment of each of a plurality of inner conductors of an engaged cable end can be achieved in a reliable and secure manner.

These and other features and advantages will be readily understood from the following Detailed Description, which should be read in conjunction with the accompanying drawings.

### BRIEF DESCRIPTION OF THE DRAWINGS

FIG. 1(A) is a perspective view of one end of a corrugated coaxial cable having an end prepared for use with a coaxial cable connector;

FIG. 1(B) is a perspective view of a smooth-walled coaxial cable having an end prepared for use with a coaxial cable connector;

FIG. 1(C) is a perspective view of the smooth-walled coaxial cable of FIG. 1(B), having a portion of the dielectric layer cored out;

FIG. 2 is a side perspective view, shown in section, of a coaxial cable connector in accordance with a first embodiment, the connector being shown in a partially engaged position;

FIG. 3 is the side sectioned perspective view of the coaxial cable connector of FIG. 2, the connector being shown in a fully engaged position;

FIG. 4 is an exploded assembly view of the coaxial cable connector of FIGS. 2 and 3;

FIG. 5 is a side perspective view, shown in section, of a coaxial cable connector in accordance with a second embodiment; and

FIG. 6 is the side sectioned perspective view of the coaxial cable connector of FIG. 5, the connector being shown in a fully engaged position.

### DETAILED DESCRIPTION

The following description relates to a coaxial cable connector that can be used in conjunction with a prepared end of a coaxial cable having multiple (i.e., more than one) center conductors. More specifically, the embodiment described herein relates to the termination of a smooth-walled coaxial cable having a cable end prepared for engagement with exemplary compression connectors. It will be readily apparent, however, that various other modifications and variations are possible, for example, utilizing other types of coaxial cable; for example, such as certain corrugated coaxial cables. In addition, various terms are used throughout this description in order to provide a suitable frame of reference with regard to the accompanying drawings. These terms are not intended to be limiting, however, except where so specifically indicated.

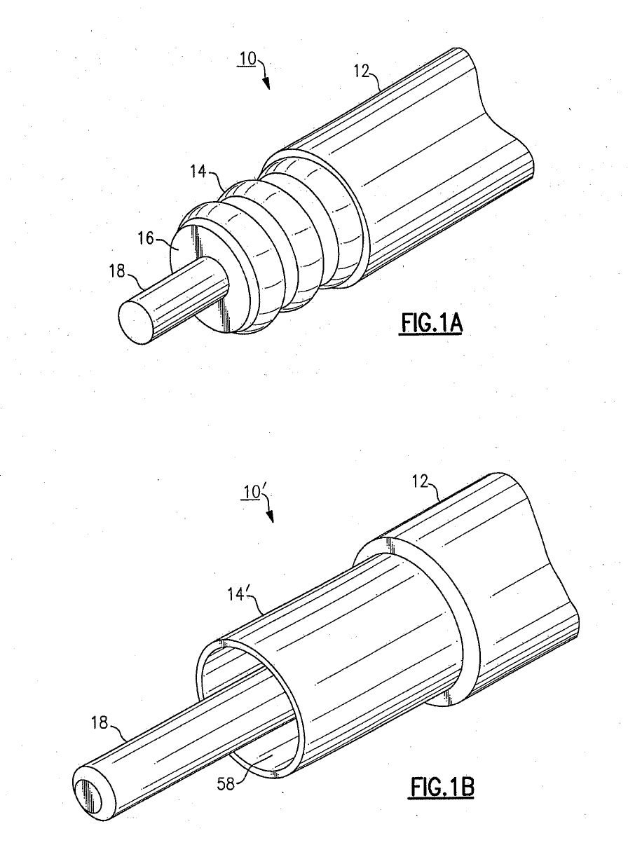

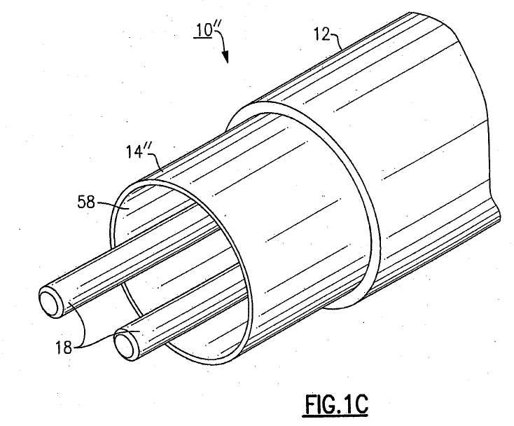

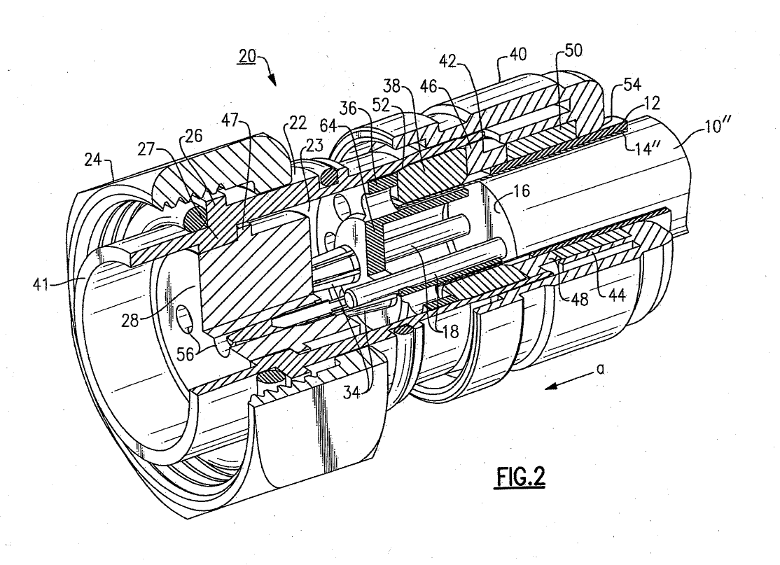

For purposes of background and referring to FIG. 1(A), there is shown an exemplary corrugated coaxial cable 10 having a cable end that is prepared for termination onto a coaxial cable connector. An insulative outer jacket 12 is cut away to expose an axial portion of a corrugated outer conductor layer 14 that comprises a plurality of annular peaks and valleys. Additional details relating to this type of coaxial cable can be found, for example, in commonly owned and co-pending U.S. Ser. No. 11/743,633 incorporated by reference herein in its entirety. Both the outer conductor layer 14 and an intermediate dielectric layer 16 are cut away from an exposed center conductor 18 at the distal end of the coaxial cable 10. It should be noted that details relating to the preparation of the cable end are well known in the field and do not form an essential part of this application.

Referring to FIG. 1(B), a smooth-walled coaxial cable 10′ is depicted as prepared for termination with a coaxial cable connector for termination. The cable 10′ is also defined by a center conductor 18, an intermediate dielectric layer 16 and an outer conductor layer 14′. An insulative outer jacket 12 initially covers each of the foregoing layers, wherein the jacket is cut away by conventional means to define an axial section of the outer conductor layer 14′ and the outer conductor layer and intermediate dielectric layer 16 are each cut away to provide an exposed center conductor 18 at the distal end of cable end. Additionally and according to this described version, the dielectric layer 16 is cored out to define a hollow 58 after both the corrugated outer conductor layer 14′ and dielectric layer 16 are cut away from the exposed center conductor 18.

FIG. 1(C) illustrates a smooth-walled cable 10″ that is somewhat similar to the above described version. However and in this specific version, the cable 10″ is defined with a plurality of center conductors 18 as opposed to a single center conductor. Such depicted cables are used, for example, in machine apparatus for transmitting control signals. Additionally and according to this version, a foam or other suitable dielectric layer (not shown in this view) is cored out, defining a hollow 58 after both the corrugated outer conductor layer 14″ and dielectric layer have been cut away from the exposed center conductor 18. This latter cable 10″ is herein utilized for purposes of each of the following described compression connectors, which is detailed as follows. It will be readily apparent that other forms of coaxial cable, including those depicted above, can be utilized. Moreover, the center conductors shown herein are solid in terms of their construction. However and as noted above, certain center conductors can also be made hollow so as to reduce material usage and stiffness for certain applications. It is further intended that the herein described connector can be used with either such variation.

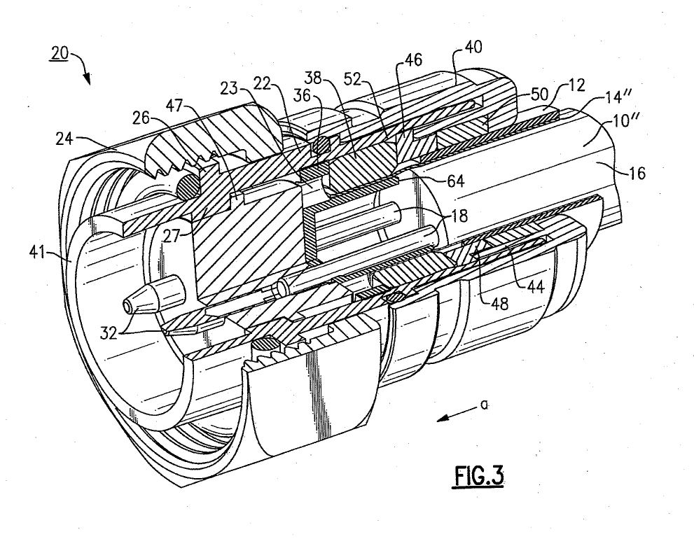

With the preceding background and referring to FIG. 2, there is shown a compression coaxial cable connector 20 made in accordance with an exemplary embodiment, the connector being shown in a partially compressed or engaged position. The connector 20 is defined by a connector body 22 in which a nut 24 is rotatably connected at one distal end 41 via an annular flange 26. For purposes of clarity, the term “distal” and “proximal” are used frequently throughout wherein all conventions that employ the terms distal and proximal shall commonly refer to these body ends. That is and for all described components, surfaces of these components facing or closest to the distal end 41 of the connector body 22 shall be referred to as “distal” while those surfaces closer to the end 42 shall be referred to as “proximal”.

The connector body 22 is defined by a center cavity or passageway 23 that retains an insulator 28, the latter component being fixedly mounted in the distal body end 41 adjacent the annular flange 26. More specifically, the insulator 28 includes an annular shoulder 47 that engages the top surface of a cylindrical retaining section 27 of the connector body 22 having a through opening or bore which a distal portion of the insulator is snugly fitted, and therefore the insulator is fixed.

Proximal of the cylindrical retaining portion 27, the interior surface within the center passageway 23 of the connector body 22 according to this embodiment is defined by a first axial section having a first diameter adjacent the proximal end 42 and a second axial section distal of the first axial section having a second diameter that is smaller than the first diameter. The two axial sections are linked by a transitional surface section 52, which is formed by means of a ramped configuration herein, though it will be appreciated that other suitable forms of transition can be utilized. The interior diameter of the second axial section is substantially constant until encountering cylindrical retaining section 27. Proximal to this latter section, the interior diameter of the center passageway 23 is expanded, though not quite as large as that of the second axial section, this retaining section extending to the distal end 41.

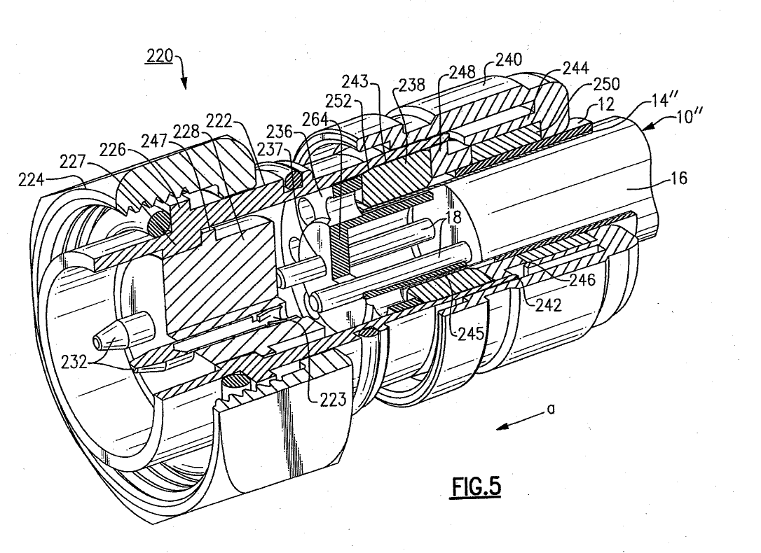

The insulator 28 according to this embodiment includes a pair of spaced apart axial through openings 56, FIG. 4, each of the openings retaining therein a hollow conductive pin 30. It should be noted, however, that the number of these openings can be varied, depending on the number of center conductors to be seized for an engaged coaxial cable.

Each hollow conductive pin 30 according to this exemplary embodiment is defined by a pin portion 32, FIG. 4, at the distal end and a collet portion 34, FIG. 4, at the opposite proximal end, noting again that the terms “distal” and “proximal” are used in conjunction with the ends 41, 42 of the connector body 22. Initially and as shown in FIG. 2, each collet portion 34 extends outwardly from a proximal surface of the insulator 28. The collet portions 34 are each defined by a set of electrical contacts formed in a cylindrical sleeve within a plurality of flexible fingers or tines, wherein the diameter of the collet portions are further defined by a transition surface 35 that gradually increases toward the proximal end of the conductive pin 30. A drive insulator or mandrel 36 is positioned for axial movement within the center passageway 23 of the connector body 22 between the extending of the extending collet portions 34 and a clamp 38, the mandrel having a series of axial openings 37 that are aligned with the insulator openings 56. An annular portion 64 extends proximally from the body of the mandrel 36 for engaging the cable end 10″, as described below.

The clamp 38 described herein is defined by an exterior surface 43 and an interior surface 45, the former being situated in intimate contact, initially, with the interior surface of the first axial section of the connector body 22 as shown in FIG. 2. The exterior surface 43 of the clamp 38 according to this embodiment is annular and preferably provided with a plurality of axial slots spaced thereabout, enabling the clamp to be inwardly compressed in a manner described below. The interior surface 45 of the clamp 38 is also annular according to this embodiment for engagement with a cable end 10″, also as described below.

The herein described compression connector 20 further includes a compression sleeve 40 that is movably attached to the body 22, the sleeve having a portion that fits over the proximal end 42 of the connector body 22, the sleeve further including an annular slot that is sized to receive the periphery of the connector body 22. A drive portion 44 of the compression sleeve 40 fits against an annular flange 46 of a drive ring 48, the drive ring 48 also engaging the clamp 38. An annular elastomeric seal element 50 fits snugly against the outer insulative jacket 12 of the prepared corrugated cable end 10″ during installation of the cable to prevent the ingress of moisture or particulate matter, while also providing strain relief of the cable and increased cable retention in the connector 20. In terms of positioning and when initially assembled, a proximal edge of the elastomeric seal element 50 abuts an interior end surface of the compression sleeve 40.

Still referring to FIG. 2 and when the prepared cable 10″, FIG. 1(C), is initially inserted into a proximal end opening 54 of the compression connector 20 in the direction shown by arrow a, the outer conductor layer 14 of the prepared cable end advances axially and initially engages the interior annular surface 45 of the clamp 38. However and in this initial configuration, the clamp diameter is sized so as not to impose any seizing force upon the outer conductor layer 14″. In the meantime, the exposed center conductor 18 of the engaged cable end 10″ extends through openings 37 provided in the drive mandrel 28 into the respective insulator 36 and the collet portions 34 of each conductive pin 30. One of the collet portions 34 is cut away in FIG. 2 to better depict this latter engagement. As noted, the collet portions 34 each extend outside of the insulator 28 initially wherein the electrical contacts disposed within the flexible finger portions do not engage directly against the center conductors 18. In addition, the annular proximal extending portion 64 of the drive mandrel 36 has extended into the formed hollow 58 of the initially engaged cable end 10″.

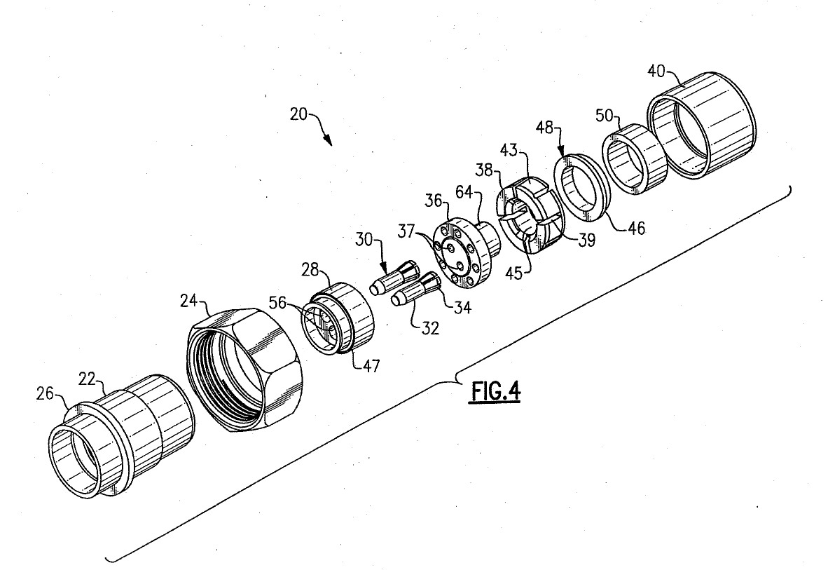

The compression sleeve 40 is acted upon by a compression tool (not shown) wherein axial movement in the direction depicted by arrow a causes the compression sleeve to move axially toward the distal end 41 of the connector body 22. This engagement causes the drive portion of the compression sleeve 40 to engage against the annular flange 46 of the drive ring 48 and the elastomeric seal element 50. As a result, the adjacent clamp 38 is also engaged and caused to be shifted axially in the direction a. When the exterior surface 43 of the clamp 38 engages the transitional surface 52, the clamp begins to compress based on the change in diameter and compliancy of the clamp material, the slots 39 enabling the clamp to conform inwardly causing the interior surface to apply greater force against the cored outer conductor layer 14″ of the engaged cable 10″. Note FIGS. 2 and 3 illustrate the cable 10 cut away to depict the intermediate dielectric layer 16 for purposes of clarity.

Referring to FIG. 3, the herein described compression connector 20 is shown with the prepared coaxial cable 10″ advanced to a fully engaged position. In this position, the distal surface of the drive mandrel 38 is caused to impinge upon the extending end of the collet sections 34. The drive mandrel 38 is supported for axial movement within the connector and therefore is also axially shifted with the clamp 38, drive ring 48, seal element 50 and compression sleeve 40. Therefore, the extending end of the collet sections 34 and center conductors 18 are each axially advanced into the respective insulator openings 56. Because the diameter of the collet transition surface 35 is larger than the fixed diameter of each insulator opening 56, as noted above, each collet section 34 is caused to gradually close as the collet portion is advanced into the insulator opening and therefore seize each of the center conductors 18. In this fully engaged position, the clamp 38 has advanced axially such that the exterior surface 43 has passed the transitional surface section 52 and now is in intimate contact with the interior surface of the second axial section. In this position, the clamp 38 buckles but also fully engages (i.e., seizes) the outer conductor layer 14″ of the cable 10″.

According to the present embodiment, the seizure of each of the inner conductors and the outer conductor layer of the cable is accomplished simultaneously or nearly simultaneously. However, the above seizure can be performed in a staggered or staged manner such that either the center conductors or the outer conductor are seized initially, followed by the other of the conductors. Additionally, the clamp described herein could be configured for seizing the outer conductive layer of a corrugated coaxial cable, such as the cable end 10 shown in FIG. 1A.

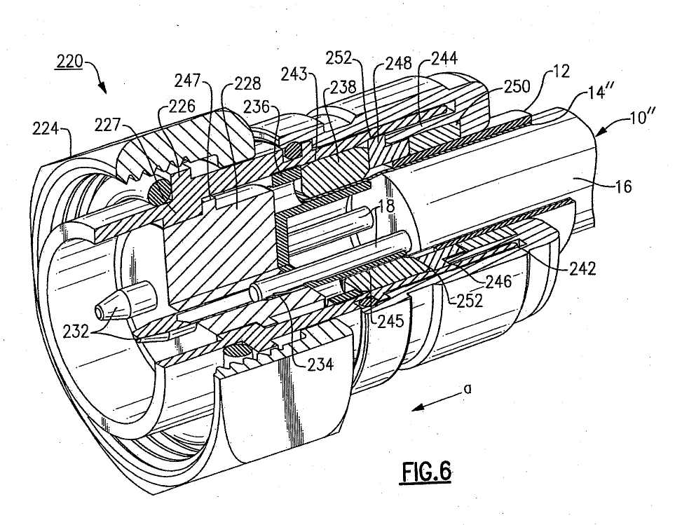

Referring to FIGS. 5 and 6 and according to another exemplary embodiment, the extending collet portions of the conductive pins can be removed in lieu of a plurality of spring portions, such as described in USSN [to be assigned—Attorney Docket No. 3037424 US01] the entire contents of which are incorporated by reference herein in order to separately seize each of a plurality of center (inner) conductors of a prepared coaxial cable end.

More specifically, the compression connector 220 for this embodiment is also described with regard to the prepared end of the smooth-walled cable 10″ of FIG. 1(C). It will be readily apparent that other configurations and variations are possible. For example, annular corrugated coaxial cables, FIG. 1(A), can also be utilized with a similar center conductor seizing mechanism. In this specific version, the compression connector 220 includes a body 222 having a center passageway or cavity 223 defined between respective distal and proximal ends 241, 242. As in the preceding, the terms “distal” and “proximal” are consistently adopted herein based on the convention of these ends. A nut 224 is secured for rotation to the exterior of the connector body 222 at the distal end 241 on an annular flange 226. The interior surface of the center passageway 223 of the connector body 222 is further defined by adjacent axial sections having different diameters; that is, a first axial section having a first diameter adjacent the proximal end 242 near end opening 254 and a second axial section having a second diameter that is larger than the first diameter; each of the diameters being linked by a transitional surface section 252, which can be ramped or otherwise suitably configured.

Referring to FIG. 5, an insulator 228 is fixedly mounted adjacent the distal end 241 within the center passageway 223. The insulator 228 is defined by a cylindrical body that includes a pair of axial through openings 256 in spaced relation, each of the openings retaining a hollow conductive pin 230. In addition, the insulator 228 according to this version includes an annular shoulder 247 that initially engages the top surface of a cylindrical retaining section 227 of the connector body 222, the retaining section having a through opening or bore within which a distal portion of the insulator is snugly fitted. As noted in the previous embodiment, the number of openings in the insulator 228 can be varied, depending on the number of center conductors 18 to be seized. Each hollow conductive pin 230 is defined by a pin portion 232 and a spring contact portion 234 on opposite ends thereof. In this version, the conductor pins 230 are fixedly mounted within each insulator opening 256.

The conductive pins 230 are aligned with respective axial openings 237 that are formed in a drive mandrel or insulator 236 disposed between the insulator 228 and a clamp 236. The drive mandrel 236 includes a pair of through openings 237, each sized to permit passage of each of the center conductors 18 of a cable end 10″ the mandrel according to this embodiment also including an annular proximal extending portion 264. As in the preceding embodiment, the clamp 236 includes an exterior annular surface 243 and an interior annular surface 245. The exterior annular surface 243 is sized to engage the interior surface of the connector body 222 and the inner annular surface 245 is configured to engage the outer conductive layer 14″ of the engaged cable end 10″.

Also and as in the preceding, the herein described compression connector 220 further includes a compression sleeve 240 that is movably attached to the body 222, the sleeve having a portion that fits over the proximal end 242 of the connector body as well as an annular interior slot that is sized to retain the periphery of the connector body. A drive portion 244 of the compression sleeve 240 fits against an annular flange 246 of a drive ring 248, the drive ring also engaging the clamp 238. An annular elastomeric seal element 250 fits snugly against the outer insulative jacket 12 of the prepared corrugated cable end 10″ during installation of the cable to prevent the ingress of moisture or particulate matter, while also providing strain relief for the cable and increased cable retention in the connector, a proximal edge of the seal element being in contact with an annular edge section of the compression sleeve 240.

Still referring to FIG. 5 and when the prepared cable 10″, FIG. 1(C), is initially inserted into the end opening 254 of the connector 220 in the direction shown by arrow a, the outer conductor layer 14 of the prepared cable end initially engages with the interior annular surface 245 of the clamp 238. In the meantime, the exposed center conductor 18 extends through openings 237 provided in the drive mandrel 228 into the respective insulator 236 and the hollow ends of each conductive pin 230. One of the conductive pins 230 is cut away in FIG. 5 to better depict this latter engagement. Also and as in the preceding, the proximal extending annular portion 264 in the proximal side of the mandrel 236 extend into the formed hollow 58 of the cable end.

The compression sleeve 240 is acted upon by a compression tool (not shown) wherein axial movement in the direction shown by arrow a causes the compression sleeve to move axially toward the insulator 228, also causing the drive ring 248 and the clamp 238 to be shifted axially in the direction a. The exterior surface 243 of the clamp 238 engages the transitional surface 252, causing the clamp to engage against the cored outer conductor layer 14″ of the engaged cable 10″. Note FIGS. 5 and 6 illustrate the cable 10 cut away to depict the intermediate dielectric layer 16 for purposes of clarity wherein as noted the specifics of the tool are known to those in the field and do not form an essential portion of this application.

Referring to FIG. 6, the multiple center insulators 18 of the prepared coaxial cable end 10″ each advance axially into the hollow conductive pins 230 and when advanced a predetermined axial distance, the center conductors are engaged by each of the spring portions 234 that extend inwardly radially toward the center of the hollow opening of the conductive pin. According to this embodiment, the spring portions 234 comprise a plurality of leaf springs that are equi-spaced about the circumference of the interior of each conductive pin. The presence of the center conductors 18 acts against the bias of the leaf springs, producing a reliable mechanical and electrical engagement when the center conductor has advanced a predetermined distance within each conductor pin.

### PARTS LIST FOR FIGS. 1-6

10 coaxial cable
10′ coaxial cable
10″ cable
12 outer insulative jacket
14 outer conductor layer
14′ outer conductive layer
14″ outer conductive layer
16 dielectric layer
18 center conductors
20 compression coaxial cable connector
22 conductor body
23 center cavity or passageway
24 nut
26 annular flange
27 cylindrical retaining portion
28 insulator
30 conductive pins
32 pin portions
34 collet portions
35 transition surfaces, collet portions
36 drive insulator or mandrel
37 openings, mandrel
38 clamp
39 slots
40 compression sleeve
41 end, body
42 end, body
43 exterior surface, clamp
44 drive portion
45 interior surface, clamp
46 annular flange
47 annular shoulder
48 drive ring
50 elastomeric seal element
52 transitional surface, ramped
54 opening
56 openings, insulator
58 hollow
64 annular extending portion
220 connector, compression
222 body, connector
223 passageway, center
224 nut
226 annular flange
227 cylindrical retaining portion
228 insulator
230 conductive pins
232 pin portions
234 spring portions
236 drive insulator or mandrel
237 openings, mandrel
238 clamp
240 compression sleeve
241 end, body
242 end, body
243 exterior surface, clamp
244 drive portion
245 interior surface, clamp
246 annular flange
247 annular shoulder
248 drive ring
250 elastomeric seal element
252 transitional surface, ramped
254 opening
256 openings, insulator
264 annular extending portion
a arrow, direction

It will be readily apparent that other variations and modifications are possible within the intended ambits of the present invention, as provided by the following claims. For example and according to another variation, a spiral corrugated coaxial cable could also be utilized in a connector design designed for multiple center conductors. In such a configured version, the spiral coaxial cable must initially be twisted when the cable is engaged to properly align a clamp having corresponding spiral corrugations with the outer conductive layer. However, a “fixed” insulator will not work properly relative to the multiple center insulators for purposes of alignment and seizure. Therefore, the insulator would be attached or otherwise interconnected to the clamp to “float” or otherwise move in concert with the clamp in order to permit initial alignment to occur.

1. A compression connector for engaging a coaxial cable, said coaxial cable including an outer conductor layer and a plurality of center conductors, said connector comprising:
a connector body having a first end, a second end and a center passageway disposed between said first and second ends;
an insulator disposed within the center passageway of said connector body adjacent said first end;
a compression sleeve attached at said second end, said sleeve being attached for axial movement relative to said connector body; and
means for seizing each of the multiple center conductors of a prepared coaxial cable end engaged within the connector when said cable end is inserted into said first end and said compression sleeve is axially advanced.

2. A connector as recited in claim 1, including a plurality of conductive pins corresponding in number to the number of center conductors of an engaged cable end, said means for seizing the center conductors being disposed in each of said conductive pins.

3. A connector as recited in claim 2, wherein said means for seizing the center conductors includes a flexible collet section formed at one end of each conductive pin.

4. A connector as recited in claim 3, wherein each said collet section is defined by a diameter that is larger than the diameter of the corresponding opening of said insulator into which said conductive pin is disposed, said collet section being initially disposed externally of said opening.

5. A connector as recited in claim 4, wherein said center conductor seizing means further includes a drive member, said drive member being disposed within said center passageway and axially movable with said compression sleeve to engage said collet sections and cause said collet sections to be driven into said insulator, such that each said center conductor is seized when advanced a predetermined distance into said insulator.

6. A connector as recited in claim 2, wherein said means for seizing the center conductors includes a plurality of spring contacts disposed in each of said conductive pins, said plurality of spring contacts being engageable with each center conductor of an engaged cable end when said conductor is advanced a predetermined distance into said pin.

7. A connector as recited in claim 1, including means for seizing an outer conductor of said engaged coaxial cable.

8. A connector as recited in claim 7, wherein said outer conductor seizing means includes a clamp having an exterior surface configured for contacting the interior surface of center passageway and an interior surface configured for engaging said outer conductor, said clamp being axially movable with a portion of said compression sleeve.

9. A connector as recited in claim 8, wherein said interior surface of said center passageway is defined by a first diameter adjacent said second end and a second diameter that is smaller than said first diameter, said first and second diameters being linked by a transitional surface portion.

10. A connector as recited in claim 1, wherein said coaxial cable is one of a corrugated and smooth-walled coaxial cable.

11. A compression connector for a coaxial cable, said coaxial cable having an outer conductor and a plurality of center conductors, said connector comprising:
a connector body having a first end, a second end and a center passageway defined between said first and second ends;
an insulator fixedly disposed within said center passageway adjacent said first end;
a compression sleeve mounted to said connector body at said second end for axial movement in connection therewith, said sleeve including a drive portion extending into said connector body;
a clamp having an exterior surface in engagement with an interior surface of said body and an interior surface configured for engagement with the outer conductor of a coaxial cable end, said clamp being movable axially with said compression sleeve, in which the interior surface of said body includes a first diameter adjacent said first end and a second diameter adjacent said second end that is smaller than said first diameter, said first and second diameters being separated by a transitional surface section; and
means for seizing the multiple center conductors of the engaged cable end, said means being included in a plurality of conductive members extending into corresponding axial openings of said insulator, said means being engageable with said center conductors when each center conductor is advanced a predetermined distance into the conductive member.

12. A connector as recited in claim 11, wherein each of said conductive members are conductive pins, each of said pins including a flexible collet portion at one end thereof.

13. A connector as recited in claim 11, wherein said means for seizing said center conductors includes a drive element disposed distally of said clamp, said drive element having an engagement surface for engaging each of said collet portions and causing said collet portions to be driven into said the axial openings of said insulator.

14. A connector as recited in claim 11, wherein said coaxial cable is at least one of a smooth-walled and a corrugated coaxial cable.

15. A connector as recited in claim 11, wherein each of said conductive members includes a plurality of spring portions disposed therein, each of said spring portions extending into a hollow opening of said conductive member into which said each center conductor is advanced.

16. A connector as recited in claim 11, wherein said exterior surface of said clamp includes a plurality of slots enabling said clamp to inwardly compress when said clamp axially traverses said transitional surface section.

17. A connector as recited in claim 15, wherein each of said spring portions are leaf springs.

18. A compression connector for a coaxial cable, said coaxial cable having an outer conductor and a plurality of inner conductors for a coaxial cable, said coaxial cable having an outer conductor and a plurality of center conductors, said connector comprising:
a connector body having a first end, a second end and a center passageway defined between said body ends;
an insulator fixedly disposed within said center passageway adjacent said first end;
a compression sleeve mounted to said connector body at said second end for axial movement in connection therewith, said sleeve including a drive portion extending into said connector body;
a clamp having an exterior surface in engagement with an interior surface of said body and an interior surface configured for engagement with the outer conductor of a coaxial cable end, said clamp being movable axially with said compression sleeve, in which the interior surface of said body includes a first diameter adjacent said first end and a second diameter adjacent said second end that is smaller than said first diameter, said first and second diameters being separated by a transitional surface section; and
a plurality of conductive members disposed within axial openings of said insulator, each of said conductive members having a hollow portion sized to receive an inner conductor, said conductive members each further including at least one seizing element that seizes each said inner conductor when said conductor is advanced a predetermined axial distance therein.

19. A connector as recited in claim 18, wherein said at least one seizing element includes a collet section.

20. A connector as recited in claim 19, wherein said collet section is initially disposed outside of said insulator, said collet section including a plurality of flexible finger portions and defined by a transition surface that is larger than the diameter of said insulator opening.

21. A connector as recited in claim 19, including a drive member that engages each said collet section and advances said collet section into said insulator to cause seizure of said inner conductor.

22. A connector as recited in claim 18, wherein said at least one seizing element includes at least one spring contact.

23. A connector as recited in claim 18, wherein said coaxial cable is at least one of a coaxial and corrugated coaxial cable.

24. A method for using a compression connector to engage a coaxial cable, said coaxial cable including an outer conductor and a plurality of inner conductors, said method comprising the steps of:
engaging a prepared cable end into a first end of a compression connector, said connector having a connector body and a compression sleeve movably attached to said first end of said body;
axially moving said compression sleeve from the first end toward an opposite second end, advancing each of the inner conductors into a corresponding number of conductive members supported within an insulator, said conductive members having at least one seizure element; and
advancing said cable end using said compression sleeve such that said plurality of inner conductors are advanced a predetermined distance into said conductive member and engaged by said at least one seizing element.

25. A method as recited in claim 24, wherein each of said conductive members is a hollow conductive pin having a flexible collet section, said collet section being disposed externally of said insulator and having a diameter that is larger than that of the insulator opening, said method including the additional steps of moving a drive member disposed within said connector body into engagement with said collet sections and causing said collet sections to be driven into said insulator, said collet sections being closed to seize said conductors.

26. A method as recited in claim 25, including the step of seizing the outer conductor of said coaxial cable when said compression sleeve is moved from said first end to said second end.

27. A method as recited in claim 26, wherein the seizing of said inner conductors and said outer conductor occurs simultaneously.

28. A method as recited in claim 26, wherein the seizing of said inner conductors occurs before or after the seizing of said outer conductor.
